(19) United States
(12) Patent Application Publication
(10) Pub. No.: US 2025/0106793 A1
(43) Pub. Date: Mar. 27, 2025

(54) METHOD AND APPARATUS FOR SYNCHORIZATION BETWEEN TERRESTRIAL NETWORK AND NON-TERRESTRIAL NETWORK

(71) Applicant: Electronics and Telecommunications Research Institute, Daejeon (KR)

(72) Inventor: Hee Wook KIM, Dejeon (KR)

(73) Assignee: Electronics and Telecommunications Research Institute, Daejeon (KR)

(21) Appl. No.: 18/896,287

(22) Filed: Sep. 25, 2024

(30) Foreign Application Priority Data
Sep. 26, 2023 (KR) 10-2023-0129890

(51) Int. Cl. H04W 56/00; H04W 84/06

(52) U.S. Cl. CPC H04W 56/0015; H04W 56/006; H04W 84/06

(57) ABSTRACT

A method of a base station may comprise: receiving a link signal from a satellite; obtaining a first reference time of the satellite from the link signal; configuring a second reference time of the base station based on the first reference time; and transmitting a downlink signal to a terminal based on the second reference time, wherein the satellite belongs to a non-terrestrial network and the base station belongs to a terrestrial network.

### CROSS-REFERENCE TO RELATED APPLICATIONS

This application claims priority to Korean Patent Applications No. 10-2023-0129890, filed on Sep. 26, 2023, with the Korean Intellectual Property Office (KIPO), the entire contents of which are hereby incorporated by reference.

### BACKGROUND

### 1. Technical Field

The present disclosure relates to a technique for synchronization between a terrestrial network and a non-terrestrial network, and more particularly, to a technique for synchronization between a terrestrial network and a non-terrestrial network, which allow the same frequency to be used by the terrestrial network and the non-terrestrial network through acquisition of time synchronization between the terrestrial network and the non-terrestrial network.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Such a communication network may provide communication services to terminals located on the ground, making it a terrestrial network (TN). Recently, there has been a growing demand for communication services not only for terrestrial entities but also for non-terrestrial entities such as unmanned aerial vehicles and satellites. In response to this, the 3GPP has been discussing technologies for non-terrestrial networks (NTN). Meanwhile, TN and NTN are typically used for different purposes by employing different frequencies. However, the need for smartphone communication and Internet of Things (IoT) services using NTN has recently emerged. In such cases, a single communication provider could offer services by leveraging both TN and NTN, complementing the shortcomings of each network. In this scenario, TN and NTN could potentially use the same frequency rather than different frequency resources. A future mobile communication system where TN and NTN are integrated in the above-described manner may not require exclusive use of frequencies for TN and NTN. Instead, they may need to coexist by sharing frequency resources, maximizing available resources through methods of frequency sharing.

### SUMMARY

The present disclosure for resolving the above-described problems is directed to providing a method and an apparatus for synchronization between a terrestrial network and a non-terrestrial network, which allow the same frequency to be used by the terrestrial network and the non-terrestrial network through acquisition of time synchronization between the terrestrial network and the non-terrestrial network.

A synchronization method between a terrestrial network and a non-terrestrial network, according to a first exemplary embodiment of the present disclosure, as a method of a base station, may comprise: receiving a link signal from a satellite; obtaining a first reference time of the satellite from the link signal; configuring a second reference time of the base station based on the first reference time; and transmitting a downlink signal to a terminal based on the second reference time, wherein the satellite belongs to a non-terrestrial network and the base station belongs to a terrestrial network.

The link signal may include a first synchronization signal/broadcast block (SSB), and the obtaining of the first reference time of the satellite from the link signal may comprise: obtaining a synchronization signal from the first SSB of the link signal; and obtaining the first reference time of the satellite from the synchronization signal.

A frequency band in which the satellite transmits the link signal may be same as a frequency band in which the base station transmits the downlink signal.

The transmitting of the downlink signal to the terminal based on the second reference time may comprise: determining a timing of the downlink signal based on the second reference time; and transmitting the downlink signal to the terminal based on the timing.

In the determining of the timing of the downlink signal based on the second reference time, the base station may set a timing for a frame and OFDM symbol of the downlink signal.

The link signal may include a first SSB, the downlink signal may include a second SSB, and the second SSB may be transmitted after the first SSB.

The link signal may include a first SSB, the downlink signal may include a second SSB, and the second SSB may be transmitted in a same frequency resource as the first SSB.

A synchronization method between a terrestrial network and a non-terrestrial network, according to a second exemplary embodiment of the present disclosure, as a method of a network synchronization device, may comprise: selecting an anchor base station from among a plurality of base stations belonging to a terrestrial network within a coverage of a satellite; configuring a first reference time of the anchor base station; calculating a first delay time between the satellite and the anchor base station; calculating a second delay time between the satellite and a target base station; and configuring a second reference time of the target base station from the first reference time using the first delay time and the second delay time.

The calculating of the first delay time between the satellite and the anchor base station may comprise: calculating a first distance between the satellite and the anchor base station based on a location of the satellite and a location of the anchor base station; and calculating the first delay time based on the first distance.

The calculating of the second delay time between the satellite and the target base station may comprise: calculating a second distance between the satellite and the target base station based on a location of the satellite and a location of the target base station; and calculating the second delay time based on the second distance.

The configuring of the second reference time of the target base station from the first reference time using the first delay time and the second delay time may comprise: calculating a delay time difference between the first delay time and the second delay time; and configuring the second reference time by reflecting the delay time difference in the first reference time.

The method may further comprise: configuring a third reference time of the satellite by reflecting the first delay time in the first reference time.

A synchronization device between a terrestrial network and a non-terrestrial network, according to a third exemplary embodiment of the present disclosure, as a base station, may comprise a processor, and the processor may cause the base station to perform: receiving a link signal from a satellite; obtaining a first reference time of the satellite from the link signal; configuring a second reference time of the base station based on the first reference time; and transmitting a downlink signal to a terminal based on the second reference time, wherein the satellite belongs to a non-terrestrial network and the base station belongs to a terrestrial network.

The link signal may include a first synchronization signal/broadcast block (SSB), and in the obtaining of the first reference time of the satellite from the link signal, the processor may cause the base station to perform: obtaining a synchronization signal from the first SSB of the link signal; and obtaining the first reference time of the satellite from the synchronization signal.

A frequency band in which the satellite transmits the link signal may be same as a frequency band in which the base station transmits the downlink signal.

In the transmitting of the downlink signal to the terminal based on the second reference time, the processor may cause the base station to perform: determining a timing of the downlink signal based on the second reference time; and transmitting the downlink signal to the terminal based on the timing.

According to the present disclosure, terrestrial networks and non-terrestrial networks may acquire time synchronization between signals of the networks. As a result, according to the present disclosure, terrestrial networks and non-terrestrial networks may not exclusively use frequencies, allowing them to coexist through frequency sharing. Furthermore, according to the present disclosure, by operating with the same frequency resources, terrestrial networks and non-terrestrial networks can minimize interference between each other, thereby enhancing the efficiency of frequency utilization.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a conceptual diagram illustrating a first exemplary embodiment of an integrated network of a terrestrial network and a non-terrestrial network.

FIG. 5 is a conceptual diagram illustrating a second exemplary embodiment of an integrated network of a terrestrial network and a non-terrestrial network.

FIG. 6 is a flowchart illustrating a first exemplary embodiment of a synchronization method between a terrestrial network and a non-terrestrial network.

FIG. 7 is a conceptual diagram illustrating a first exemplary embodiment of a method for transmitting SSB(s) of a non-terrestrial network and a terrestrial network.

FIG. 8 is a flowchart illustrating a second exemplary embodiment of a synchronization method between a terrestrial network and a non-terrestrial network.

FIG. 9 is a conceptual diagram for describing a process of calculating a delay time between a satellite and a terrestrial base station.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g. long-term evolution (LTE) communication network), a 5G communication network (e.g. new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

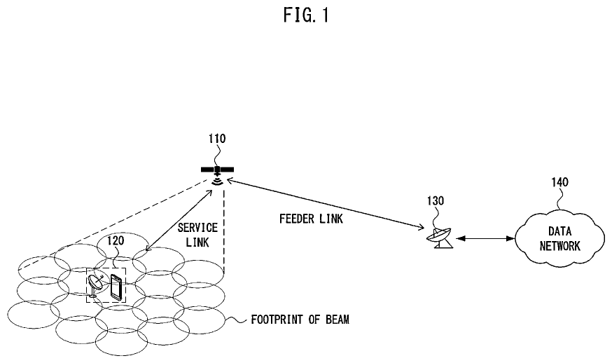

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical. The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

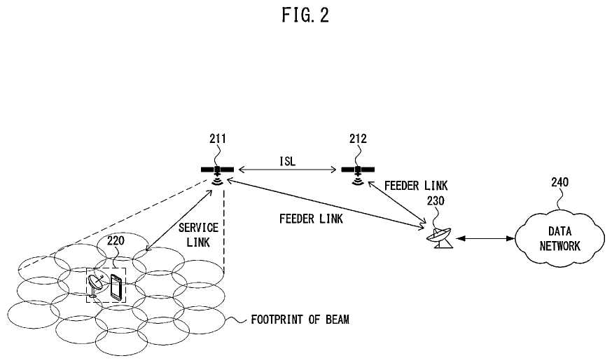

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

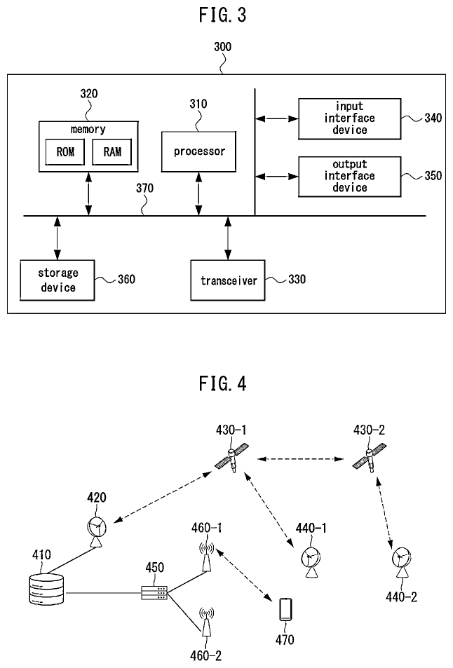

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’. Parameters for the scenarios defined in Table 1 may be defined as shown in Table 2 below.

TABLE 2

| | Scenarios A and B | Scenarios C and D |
|---|---|---|
| Altitude | 35,786 km | 600 km |
| | | 1,200 km |
| Spectrum | <6 GHz (e.g. 2 GHz) | |
| (service link) | >6 GHz (e.g. DL 20 GHz, UL 30 GHz) | |
| Maximum | 30 MHz for band <6 GHz | |
| channel bandwidth | 1 GHz for band >6 GHz | |
| capability | | |
| (service link) | | |
| Maximum distance | 40,581 km | 1,932 km |
| between satellite | | (altitude of 600 km) |
| and communication | | 3,131 km |
| node (e.g. UE) | | (altitude of 1,200 km) |
| at the minimum | | |
| elevation angle | | |
| Maximum round | Scenario A: | Scenario C: (transparent |
| trip delay | 541.46 ms | payload: service |
| (RTD) | (service and | and feeder |
| (only propagation | feeder links) | links) |
| delay) | Scenario B: | −5.77 ms |
| | 270.73 ms | (altitude of 60 0 km) |
| | (only service link) | −41.77 ms |
| | | (altitude of 1,200 |
| | | km) |
| | | Scenario D: (regenerative |
| | | payload: only service link) |
| | | −12.89 ms (altitude of 600 km) |
| | | −20.89 ms (altitude of 1,200 |
| | | km) |
| Maximum | 16 ms | 4.44 ms (altitude |
| delay variation | | of 600 km) |
| within a single beam | | 6.44 ms (altitude |
| | | of 1,200 km) |
| Maximum | 10.3 ms | 3.12 ms (altitude of 600 km) |
| differential delay | | 3.18 ms (altitude of 1,200 km) |
| within a cell | | |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario | Scenario | Scenario | Scenario |
|---|---|---|---|---|
| | A | B | C1-2 | D1-2 |
| Satellite altitude | 35,786 km | | 600 km | |
| Maximum RTD in a | 541.75 ms | 270.57 ms | 28.41 ms | 12.88 ms |
| radio interface between | (worst case) | | | |
| base station and UE | | | | |
| Minimum RTD in a | 477.14 ms | 238.57 ms | 8 ms | 4 ms |
| radio interface between | | | | |
| base station and UE | | | | |

Meanwhile, it is expected that the mobile communication network beyond 5G will evolve in the direction of combining or cooperating with terrestrial networks and satellite networks (i.e., non-terrestrial networks (NTN)). In such integrated system of terrestrial networks and satellite networks, commonality between satellite and terrestrial radio interfaces may be very important when considering the cost of terminals. Accordingly, NR-based NTN standardization is actively underway in the 3GPP. Furthermore, the 3GPP is currently working on the standardization and research of NR/LTE/narrowband internet of things (NB-IoT)-based NTN radio interfaces, taking into consideration the characteristics such as long round-trip delays, delay differences between terminals, large cell coverage, and significant Doppler shifts between base stations and terminals compared to terrestrial mobile networks. The research is being conducted with a focus on addressing delay differences within the cell coverage and the power-constrained satellite environment.

Meanwhile, TN and NTN may be used for different purposes by mostly using different frequencies. However, the need for smartphone communication and IoT services using NTN may arise recently. In such cases, a single telecommunications operator may provide services by utilizing TN and NTN to complement the shortcomings of the two networks. In this case, TN and NTN may use the same frequency rather than using different frequency resources. This may complicate the system configuration, but it may have various advantages.

Meanwhile, different orthogonal frequency division multiplexing (OFDM)-based systems may operate in the same frequency. Time synchronization may be required. For example, TN and NTN may be operated exclusively in frequency bands allocated by the International Telecommunication Union (ITU) or each country. For example, frequency bands allocated to terrestrial IMT, such as 1920-1980 MHz (uplink)/2110-2170 MHz (downlink), may be used exclusively for TN, and may not be used for NTN in the same area and at the same time considering the interference with other systems. For the same reason, frequency bands allocated to satellite IMT, such as 1980-2010 MHz (uplink)/2110-2170 MHz (downlink), may be exclusively used for NTN, and may not be used for TN in the same area and at the same time, considering the interference effects with other systems. As described above, TN and NTN may exclusively use frequencies. In this case, interference between systems may not occur. Accordingly, system construction and operation can be facilitated.

However, in this case, when TN and NTN exclusively use the frequency, the available frequency resources may not be utilized to the maximum extent. In addition, the frequency may be changed during handover between TN and NTN. Accordingly, a handover time may be prolonged. In addition, the implementation complexity of the terminal may increase due to the change in radio frequency (RF) frequency. In addition, when one operator simultaneously operates TN and NTN, the number of frequencies to be allocated to one operator may increase depending on the bandwidth of the mobile communication system, which may not be suitable for future cellular communication.

As described above, the future mobile communication system in which TN and NTN are unified may not exclusively use the frequency in TN and NTN, and may require methods for coexisting with each other through frequency joint use to maximize the utilization of available resources. Considering the above, a terrestrial network and a non-terrestrial network in the present disclosure may have the same frequency and serve the same area. In other words, in the present disclosure, a plurality of TN base stations may exist within a wide service beam coverage of the NTN via satellites. In this case, the TN base stations in the present disclosure may have narrower service coverage than the NTN.

In addition, the TN and the NTN in the present disclosure may operate in the same frequency band without changing the frequency band. Accordingly, the TN and the NTN in the present disclosure may increase frequency usage efficiency through cooperative frequency resource sharing while reducing interference effects. To this end, the present disclosure provides methods for aligning signals between NTN and TN based on different OFDM schemes. In other words, the present disclosure provides methods for aligning frame starting points or OFDM symbol starting points of TN and NTN. Specifically, the present disclosure provides two approaches: a scheme for aligning a TN signal based on an NTN signal and a scheme for a central core network to determine a reference time of a TN base station using location information of a satellite and the TN base station.

Hereinafter, the present disclosure will describe preferred exemplary embodiments in detail. The exemplary embodiments may be based on an NR-based satellite mobile communication system. However, methods of the present disclosure may be applicable as methods for synchronizing signals between any other wireless communication systems. Coexistence or cooperation between TN and NTN may be an essential element in constructing a truly global three-dimensional (3D) network by complementing the shortcomings of the two networks. In addition, coexistence or cooperation between TN and NTN may be one of the important tasks in 6G. It may be a better approach for existing TN operators to share the existing TN frequencies for NTN rather than securing additional frequencies for NTN at a high cost.

FIG. 4 is a conceptual diagram illustrating a first exemplary embodiment of an integrated network of a terrestrial network and a non-terrestrial network.

Referring to FIG. 4, a core network 410 may manage TN(s) and NTN(s) by integrating them. To this end, the core network 410 may be equipped with a network synchronization device. The core network may be a 5G core network or a 6G core network. The core network 410 may be connected to an NTN ground station 420 via a backhaul. Here, the NTN ground station 420 may be an NTN base station-central unit (i.e. NTN gNB-CU).

The NTN ground station 420 may be connected to a first NTN satellite 430-1 via a midhaul or fronthaul. In this case, the first NTN satellite 430-1 may be connected to a second NTN satellite 430-2 via an inter-satellite link (ISL). Here, each of the first NTN satellite 430-1 and the second NTN satellite 430-2 may be an NTN base station-distributed unit (i.e. NTN gNB-DU). The NTN ground station 420 may perform base station functions together with the first NTN satellite 430-1 and the second NTN satellite 430-2. Here, a split scheme of the base station functions between the NTN ground station 420, the first NTN satellite 430-1, and the second NTN satellite 430-2 may vary depending on a system configuration of the operator.

The first NTN satellite 430-1 may be connected to a first NTN terminal 440-1 via a service link or a user link. In addition, the second NTN satellite 430-2 may be connected to a second NTN terminal 440-2 via a service link or a user link. Here, it may be assumed that the service link or user link follows the 3GPP NTN technical specifications.

Meanwhile, the core network 410 may be connected to a TN base station-central unit/remote unit (i.e. TN gNB-CU/RU) 450 via a backhaul. In addition, the TN base station-central unit 450 may be connected to a first TN base station-distributed unit/remote unit (i.e. TN gNB-DU/RU) 460-1 via a midhaul or fronthaul. Additionally, the TN base station-central unit 450 may be connected to a second TN base station-distributed unit/remote unit (i.e. TN gNB-DU/RU) 460-2 via a midhaul or fronthaul.

The TN base station-central unit 450 may perform base station functions together with the first TN base station-distributed unit/remote unit 460-1 and the second TN base station-distributed unit/remote unit 460-2. Here, a split scheme of the base station functions between the TN base station-central unit 450, the first TN base station-distributed unit/remote unit 460-1, and the second TN base station-distributed unit/remote unit 460-2 may vary depending on a system configuration of the operator. The first TN base station-distributed unit/remote unit 460-1 may be connected to a first TN terminal 470 via a service link or user link. Here, it may be assumed that the service link or user link follows the 3GPP TN technical specifications.

In the integrated network, the service link or user link between the NTN satellite and the NTN terminal and the service link or user link between the TN base station and the TN terminal may share frequencies.

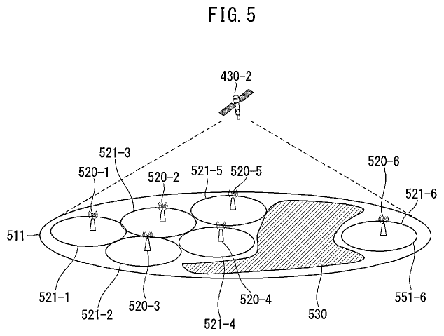

FIG. 5 is a conceptual diagram illustrating a second exemplary embodiment of an integrated network of a terrestrial network and a non-terrestrial network.

Referring to FIG. 5, a satellite 510 of an NTN may have a wide service coverage 511. A plurality of TN base stations 520-1 to 520-6 may be located in the service coverage 511 of the satellite. As described above, since the service coverage 511 of the satellite 510 is very wide, TN cells 521-1 to 521-6 of the plurality of TN base stations 520-1 to 520-6 may exist. However, depending on a situation, a TN coverage hole 530 that the TN cannot service may exist.

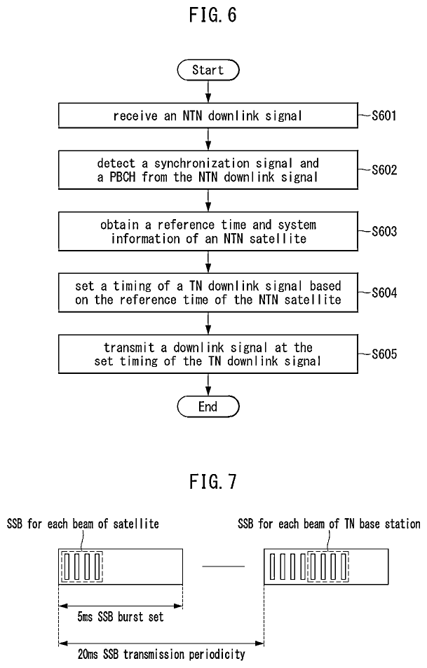

FIG. 6 is a flowchart illustrating a first exemplary embodiment of a synchronization method between a terrestrial network and a non-terrestrial network.

Referring to FIG. 6, an NTN satellite may broadcast a downlink signal including a synchronization signal/broadcast block (SSB). Then, a TN base station may receive the downlink signal including the SSB (S601). Then, the TN base station may detect a synchronization signal (e.g. primary/secondary synchronization signal (PSS/SSS)) in the SSB of the received downlink signal and may detect a PBCH (S602).

Accordingly, the TN base station may obtain a reference time of the NTN satellite from the synchronization signal, and may obtain system information through a master information block (MIB) of the PBCH (S603). Thereafter, the TN base station may set a timing for a downlink signal for the TN based on the reference time of the NTN satellite (S604). In this case, the TN base station may set a timing for a frame and OFDM symbol. Subsequently, the TN base station may transmit the downlink signal for the TN based on the set timing (S605).

The above-described method of synchronizing the TN and the NTN may be to acquire network synchronization for the TN based on the downlink signal transmitted from the NTN satellite. To this end, the TN base station may extract the reference time of the NTN satellite based on the synchronization signal and PBCH from the downlink frame of the NTN, and configure its own downlink frame signal according to the extracted reference time.

Meanwhile, when an antenna of the TN base station is directed toward the ground surface (i.e. the antenna of the TN base station is tilted downward), the NTN satellite signal may not be received smoothly. In this case, the TN base station may extract a reference time from an uplink signal transmitted from the NTN terminal on the ground to the NTN satellite. In addition, the TN base station may be equipped with a separate satellite signal reception-only antenna to smoothly receive the NTN satellite signal. Through this process, the TN base station may transmit its own SSB signal in synchronization with the NTN signal after extracting the reference time and system information of the NTN satellite.

FIG. 7 is a conceptual diagram illustrating a first exemplary embodiment of a method for transmitting SSB(s) of a non-terrestrial network and a terrestrial network.

Referring to FIG. 7, a TN base station may not set a reference time of a network while monitoring an NTN signal in a state where it is not synchronized with the NTN signal. Therefore, the TN base station may not transmit SSBs. Therefore, a satellite may transmit SSBs during a time when the TN base station does not transmit SSBs. In this case, when the satellite utilizes multiple beams, multiple SSBs may be transmitted according to the number of the multiple beams.

Based on the SSBs of the NTN satellite transmitted in the above-described manner, the TN base station may identify a reference time for configuring a frame and OFDM symbol. Then, the TN base station may transmit SSBs of the TN base station at an SSB transmission time of a next SSB transmission cycle after the SSBs of the satellite according to the identified reference time. If the TN base station also uses multiple beams, the TN base station may transmit as many SSBs as the number of beams after the SSBs of the NTN. To this end, the NTN may allocate resources by considering sharing the frequency with the TN base station when configuring a downlink frame of the NTN satellite. In other words, the NTN may allocate resources by considering resources to be used in the TN. Alternatively, the two networks may transmit different signals in the same resources through non-orthogonal multiple access (NOMA). In this case, the terminals may demodulate the NOMA signals.

Meanwhile, although the TN base station transmits the SSBs after the SSBs of the NTN satellite, the TN base station may transmit the SSB by utilizing the same resources as the SSBs of the NTN. In this case, the terminals in the TN coverage may receive the SSBs of the TN with a higher power than the SSBs of the NTN. On the other hand, the terminals in the TN coverage hole may receive only the SSBs of the NTN. The terminal in the TN coverage may feedback an index of an SSB with a high reception power among the SSBs of the TN base station. Therefore, the terminal in the TN coverage may automatically perform link setup with the TN. In the case of a terminal belonging to the NTN coverage (i.e. TN coverage hole), a reception power of the SSB of the TN base station is lower than a reception power of the SSB of the NTN satellite, so link setup with the NTN may be performed based on the SSB of the NTN satellite. Therefore, each of the terminals may synchronize with an appropriate base station through the SSB. However, a terminal at an edge of the TN coverage may receive the SSB of the NTN and the SSB of the TN with similar power. In this case, the terminal may have difficulty in an initial access through the SSB.

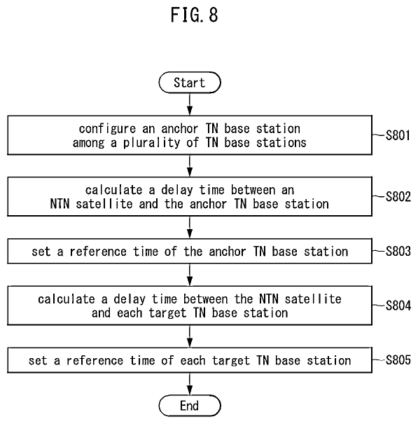

FIG. 8 is a flowchart illustrating a second exemplary embodiment of a synchronization method between a terrestrial network and a non-terrestrial network.

Referring to FIG. 8, a network synchronization device of a core network may configure one TN base station among a plurality of TN base stations within an NTN coverage as an anchor TN base station (S801). Then, the network synchronization device may calculate a distance between a satellite and the anchor TN base station using location information of the satellite and location information of the anchor TN base station. Then, the network synchronization device may calculate a delay time of the anchor TN base station based on the distance between the satellite and the anchor TN base station (S802). Subsequently, the network synchronization device may set a reference time for the anchor TN base station (S803).

Then, the network synchronization device may calculate a distance between the satellite and each target TN base station using location information of the satellite and location information of each target TN base station excluding the anchor TN base station. Afterwards, the network synchronization device may calculate a delay time of each target TN base station based on the distance between the satellite and each target TN base station (S804). Then, the network synchronization device may set a reference time of each target TN base station by considering the reference time of the anchor TN base station and the delay time of each target TN base station (S805).

In the above-described method of synchronizing the TN and the NTN, the core network may configure one anchor TN base station among multiple TN base stations within the NTN coverage and set network reference times of the remaining TN base stations and the NTN satellite based on the configured anchor TN base station. By configuring one TN base station (e.g. TN base station located directly under the satellite) within the coverage of the NTN satellite as an anchor, timings of other TN base stations may be adjusted according to an orbit of the NTN satellite.

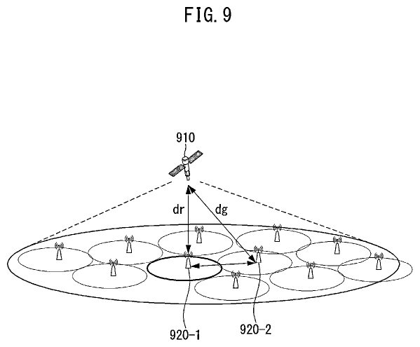

FIG. 9 is a conceptual diagram for describing a process of calculating a delay time between a satellite and a terrestrial base station.

Referring to FIG. 9, a network synchronization device of a core network may calculate a first distance dr between a satellite 910 and an anchor TN base station 920-1 based on locations of the satellite 910 and the anchor TN base station 520-1. In addition, the network synchronization device of the core network may calculate a first delay time Da between the satellite 910 and the anchor TN base station 920-1. In other words, the network synchronization device may calculate the first delay time by dividing the first distance dr by the speed of light c.

The network synchronization device of the core network may calculate a second distance dg between the satellite 910 and a target TN base station 920-2 based on locations of the satellite 910 and the target TN base station 920-2. In addition, the network synchronization device of the core network may calculate a second delay time Dt between the satellite 910 and the target TN base station 920-2. In other words, the network synchronization device may calculate the second delay time by dividing the second distance dg by the speed of light c.

Then, the network synchronization device may calculate a delay time difference Td between the first delay time and the second delay time. In other words, the network synchronization device may calculate the delay time difference using an equation Td=(dg−dr)/c. Then, the network synchronization device may set a first reference time of the anchor TN base station 920-1. Accordingly, the network synchronization device may set a second reference time of the target TN base station 920-2 by delaying the first reference time by the delay time difference. In addition, the network synchronization device may set a third reference time of the satellite 910 by delaying the first reference time by the first delay time.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a base station, comprising:
receiving a link signal from a satellite;
obtaining a first reference time of the satellite from the link signal;
configuring a second reference time of the base station based on the first reference time; and
transmitting a downlink signal to a terminal based on the second reference time,
wherein the satellite belongs to a non-terrestrial network and the base station belongs to a terrestrial network.

2. The method according to claim 1, wherein the link signal includes a first synchronization signal/broadcast block (SSB), and the obtaining of the first reference time of the satellite from the link signal comprises:
obtaining a synchronization signal from the first SSB of the link signal; and
obtaining the first reference time of the satellite from the synchronization signal.

3. The method according to claim 1, wherein a frequency band in which the satellite transmits the link signal is same as a frequency band in which the base station transmits the downlink signal.

4. The method according to claim 1, wherein the transmitting of the downlink signal to the terminal based on the second reference time comprises:
determining a timing of the downlink signal based on the second reference time; and
transmitting the downlink signal to the terminal based on the timing.

5. The method according to claim 4, wherein in the determining of the timing of the downlink signal based on the second reference time, the base station sets a timing for a frame and OFDM symbol of the downlink signal.

6. The method according to claim 1, wherein the link signal includes a first SSB, the downlink signal includes a second SSB, and the second SSB is transmitted after the first SSB.

7. The method according to claim 1, wherein the link signal includes a first SSB, the downlink signal includes a second SSB, and the second SSB is transmitted in a same frequency resource as the first SSB.

8. A method of a network synchronization device, comprising:
selecting an anchor base station from among a plurality of base stations belonging to a terrestrial network within a coverage of a satellite;
configuring a first reference time of the anchor base station;
calculating a first delay time between the satellite and the anchor base station;
calculating a second delay time between the satellite and a target base station; and
configuring a second reference time of the target base station from the first reference time using the first delay time and the second delay time.

9. The method according to claim 8, wherein the calculating of the first delay time between the satellite and the anchor base station comprises:
calculating a first distance between the satellite and the anchor base station based on a location of the satellite and a location of the anchor base station; and
calculating the first delay time based on the first distance.

10. The method according to claim 8, wherein the calculating of the second delay time between the satellite and the target base station comprises:
calculating a second distance between the satellite and the target base station based on a location of the satellite and a location of the target base station; and
calculating the second delay time based on the second distance.

11. The method according to claim 8, wherein the configuring of the second reference time of the target base station from the first reference time using the first delay time and the second delay time comprises:
calculating a delay time difference between the first delay time and the second delay time; and
configuring the second reference time by reflecting the delay time difference in the first reference time.

12. The method according to claim 8, further comprising: configuring a third reference time of the satellite by reflecting the first delay time in the first reference time.

13. A base station comprising a processor, wherein the processor causes the base station to perform:
receiving a link signal from a satellite;
obtaining a first reference time of the satellite from the link signal;
configuring a second reference time of the base station based on the first reference time; and
transmitting a downlink signal to a terminal based on the second reference time,
wherein the satellite belongs to a non-terrestrial network and the base station belongs to a terrestrial network.

14. The base station according to claim 13, wherein the link signal includes a first synchronization signal/broadcast block (SSB), and in the obtaining of the first reference time of the satellite from the link signal, the processor causes the base station to perform:
obtaining a synchronization signal from the first SSB of the link signal; and
obtaining the first reference time of the satellite from the synchronization signal.

15. The base station according to claim 13, wherein a frequency band in which the satellite transmits the link signal is same as a frequency band in which the base station transmits the downlink signal.

16. The base station according to claim 13, wherein in the transmitting of the downlink signal to the terminal based on the second reference time, the processor causes the base station to perform:
determining a timing of the downlink signal based on the second reference time; and
transmitting the downlink signal to the terminal based on the timing.
